(19) United States
(12) Patent Application Publication
(10) Pub. No.: US 2007/0143727 A1
(43) Pub. Date: Jun. 21, 2007

(54) Method of designing layout of multipower integrated circuit

(76) Inventors: Muneaki Kyoya, Tokyo (JP); Shigeo Miya, Kanagawa (JP); Kazuki Nagai, Kanagawa (JP)

Correspondence Address: MCDERMOTT WILL & EMERY LLP, 600 13TH STREET, N.W., WASHINGTON, DC, 20005-3096, US

(21) Appl. No.: 11/637,738

(22) Filed: Dec. 13, 2006

(30) Foreign Application Priority Data
Dec. 13, 2005 (JP) 2005-359195

(51) Int. Cl. G06F 17/50

(52) U.S. Cl. 716/11; 716/8; 716/12; 716/6

(57) ABSTRACT

In a layout design, there are executed a step 201 of defining a permitted connecting relationship of an interface signal to be transmitted across different power supplies, a step 202 of extracting the interface signal between the different power supplies based on information about each of the power regions and information about a cell connection and optimizing a circuit in such a manner that the connecting relationship of the interface signal between the different power supplies is set to be one-to-one, a logic cell arranging step 203, a step 204 of verifying whether a logic cell of the interface signal between the different power supplies is arranged in a correct power region or not, an arrangement synthesizing step 205, a step 206 of confirming a timing and a slew before wiring, an arrangement correcting step 207, and a wiring step 208. Consequently, it is possible to carry out the verification between the different power supplies in consideration of physical information as well as logic information.

### BACKGROUND OF THE INVENTION

1. Filed of the Invention

The present invention relates to a method of designing a layout which enhances an operating reliability in a multipower semiconductor integrated circuit.

2. Description of the Related Art

In recent years, an increase in a scale, a complicatedness and an integration of a semiconductor integrated circuit has advanced with a remarkable progress of a semiconductor technique. At the same time, it is important to implement a reduction in a consumed power in the semiconductor integrated circuit related to a mobile apparatus and a large number of techniques have been developed.

A multipower designing technique for reducing a power of a circuit by dividing a power system for each function of the semiconductor integrated circuit and cutting off a voltage is effective for reducing a consumed power. A design of a multipower semiconductor integrated circuit is more complicated than a single power semiconductor integrated circuit and a great deal of period is required for a development. In a recent system LSI design, moreover, there has been required a designing technique for guaranteeing an operating reliability of the multipower semiconductor integrated circuit and shortening a development period.

In a multipower designing technique, particularly, a semiconductor integrated circuit using a method of cutting off a power supply of a non-operating circuit has a function of generally fixing a signal transmitted from a cutoff circuit for a non-power cutoff circuit in order to prevent a deterioration in a transistor due to a standby current and a reduction in an operating reliability due to a current leakage in the case in which a power cutoff circuit and an operating circuit are provided together (for example, see JP-A-2003-218682 Publication).

In a layout design of a multipower semiconductor integrated circuit in which a circuit for cutting off a power and a non-power cutoff circuit are provided together, it is necessary to divide a region logically and physically for each of power systems in order to distinguish the power systems from each other.

At a step of arranging a standard cell in the layout design, a hierarchical layout technique for separating hierarchies for each power system is employed for preventing standard cells of the same system from being arranged in different power regions. However, there is a fear of an increase in a man-hour and an area in the hierarchical layout technique. In recent years, a method of designing a multipower semiconductor integrated circuit in the same hierarchy has been required.

In the case in which the design is carried out in the same hierarchy, there is a problem in that it is impossible to guarantee that a standard cell to be added is arranged in a desirable power region at all of steps of optimizing circuits for an arrangement synthesis and a clock tree generation in addition to the problem of the mixed arrangement of the standard cell in the different power regions.

It is possible to confirm, by a function verifying simulation, whether a correct operation can be guaranteed as a logic circuit when a power is supplied and cut off or not (for example, see JP-A-2002-259487). In a physical respect, however, the conventional art is insufficient for verifying whether a normal operation can be carried out when the power is supplied and cut off. For example, in the case in which a cell to be arranged in a power cutoff region is arranged in a non-cutoff region, there is a possibility that a current leakage might be generated in a transistor to be the non-cutoff region by a propagation of an undefined value signal sent from the cutoff circuit, resulting in a deterioration in an operating reliability.

At present, a method of automatically detecting their physical drawbacks has not been established. Even if a function verifying simulation is executed after a layout designing step, it is impossible to detect a problem because physical information is not included. In addition, even if the problem can be found by the function verification, a correction of a circuit at the layout designing step is generated. For this reason, a backtrack man-hour of a design is great.

In a multipower semiconductor integrated circuit, the conventional art is insufficient for guaranteeing a normal operation when a power is supplied and cut off in a physical respect in the case in which a power cutoff circuit and a non-power cutoff circuit are provided together. For this reason, there are various drawbacks as described above.

In a method of designing a bottom-up in which a logical synthesis is carried out for each circuit function and an assembly is implemented as a net list for one chip, even if a fan out is small in each block, there is often generated the case in which a multi-fan out is generated on a one-chip level. Usually, a countermeasure is taken against the multi-fan out by an automatic optimization for one chip.

On the other hand, a power is cut off every function in a semiconductor integrated circuit design in which different power sources are provided together. For this reason, a power cutoff device for fixing a signal is mounted in order to suppress a leakage on a receiving side of a signal line provided across different power regions. However, the signal between the different power supplies cannot be automatically subjected to the physical guarantee and verification for the leakage and the undefined propagation as described above. Even if a signal to be transmitted across the different power supplies causes the multi-fan out on a logic level, therefore, it is excluded from an optimizing target.

Also in the case in which a slew is generated in addition to the multi-fan out, the signal to be transmitted between the different power supplies is excluded from an automatic optimizing target. For this reason, there is a possibility that a slew error might be generated and a timing error might be left at a poststep. In the case in which the error remains, a correction is manually carried out at a correcting step to be executed by a design change. For this reason, a man-hour and a development period are increased.

### SUMMARY OF THE INVENTION

It is an object of the invention to provide an optimum logic cell arrangement algorithm for a signal to be transmitted across different power supplies in a multipower semiconductor integrated circuit. Moreover, it is an object of the invention to provide an interface circuit between different power supplies which can previously suppress the generation of a slew error and a timing error at a poststep.

In order to solve the problems of the invention, as a first step, a power region and a level fixing device are recognized to insert a driving buffer in order to prevent the generation of a slew error for a multi-fan out signal which is transmitted across different power supplies and the generation of a leakage current.

Specific description will be given. In a semiconductor integrated circuit having a net list structure in which power systems are separated on a logic module unit, a net between modules having different power systems is extracted and a fan out of the net is extracted.

In the case in which the fan out is not one, a module on an output side and that on an input side are detected. In the case in which a connection is carried out from a cutoff module to a non-cutoff module, a driving buffer is inserted into a cutoff side. In the case in which a connection is carried out from the non-cutoff module to the cutoff module, the driving buffer is automatically inserted by referring to a table defining such a relationship between an input and an output as to insert the driving buffer into the cutoff module.

As a second step, a connection between different power supplies is set to be one to one by the insertion of the buffer.

As a third step, a signal between different power supplies is extracted for a net to which a countermeasure is taken, and a countermeasure is taken in such a manner that a cell linked to the net is arranged close at an automatic arranging step. More specifically, the net between the different power supplies which is extracted at the first step is output as a list and such a restriction that front and rear cells linked to the net provided in the list are arranged close at the automatic arranging step is given to an automatic arranging tool.

As a fourth step, it is verified whether the arranged cell is present in a correct power region or not. More specifically, in a semiconductor integrated circuit having at least two power regions and one power cutoff region, and a non-power cutoff region, a first power region is represented as A and the other power region is represented as B.

In the case in which the power region A is a cutoff region and the power region B is a non-cutoff region, coordinates of the power region A are extracted and front and rear cells linked to a net are extracted from the net provided across the power supplies which is detected at the first step. In case of a signal to be sent from A to B, a relationship between the respective cells in A and B is determined from a table defined at the first step, and coordinates of the cell in a former stage are extracted and it is verified whether the cell is present in the coordinates of the region A or not.

In a semiconductor integrated circuit in which coordinates of a cell in a latter stage are extracted and the coordinates thus extracted are present in the region B, and such a power cutoff device as to suppress a current leakage is mounted, similarly, it is simultaneously verified whether the cell of B is the cutoff device or not.

As a fifth step, in the case in which the cell is not arranged in the correct power region by the verification at the fourth step, information about coordinates of a standard cell is extracted from a DEF and a standard cell coordinate value of the DEF is rewritten so as to be included in the power region. For all of the cells in violation which are verified at the fourth step, the same processing is repeated and the corrected DEF is read into a layout tool again so that the cells in violation are corrected automatically.

The techniques can be applied to the verification as to whether a level shifter is present in a specified power region in a multipower integrated circuit in the case in which electric potentials of the power regions are different from each other in addition to the case in which the different power regions include the power cutoff region and the non-power cutoff region.

By executing the layout designing method according to the invention, it is possible to simultaneously consider logic and physical information in power cutoff and between different source voltages in the multipower semiconductor integrate circuit. Therefore, an optimum arrangement algorithm for a logic cell of a signal transmitted across the different power supplies can be implemented easily and a verifying technique thereof can also be provided. Consequently, it is possible to prevent a deterioration in a transistor from being caused by a leakage current of an undefined signal propagation and to shorten a design period, and furthermore, to enhance a reliability.

### BRIEF DESCRIPTION OF THE DRAWINGS

FIG. 1 is a diagram typically illustrating an example of a floor plan of a multipower semiconductor integrated circuit,

FIG. 2 is a flowchart showing a method of designing a layout of a multipower integrated circuit according to an embodiment of the invention,

FIG. 3 is a diagram showing an example of a logic cell inserting policy table between different power supplies according to the invention,

FIG. 4 is a circuit diagram typically showing a relationship between triangular marks in the table of FIG. 3,

FIG. 5 is a circuit diagram typically showing a relationship between circular marks in the table of FIG. 3,

FIG. 6 is a circuit diagram showing an example of multibranching of a signal to be transmitted across the different power supplies causing the generation of a slew error,

FIG. 7 is a flowchart showing a verification algorithm for a logic cell arrangement in a power region, and

FIG. 8 is a flowchart showing a slew countermeasure algorithm of a multibranching signal to be transmitted across the different power supplies.

### DESCRIPTION OF THE PREFERRED EMBODIMENTS

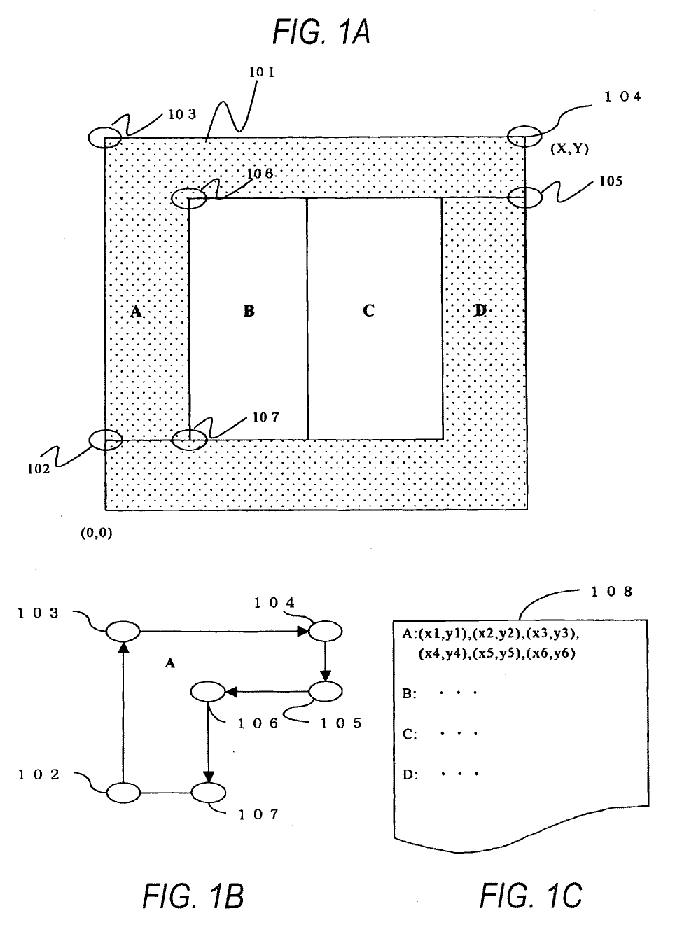

FIG. 1 is a diagram typically illustrating an example of a floor plan of a multipower semiconductor integrated circuit. In FIG. 1(a), A and D indicate regions to which a power is always supplied exclusively and B and C indicate regions in which a power supply is cut off when functions are not used as circuits, and they serve as different power regions, respectively.

It is assumed that a power region 101 shown in FIG. 1(a) can define both a rectangle and a non-rectangle. By extracting coordinates of each corner for the power region A and defining them as a set of the rectangles, it is possible to easily carry out a coordinate representation in each of the power regions as shown in FIG. 1(b). After the power region is defined, information about the power region is output as a file shown in FIG. 1(c).

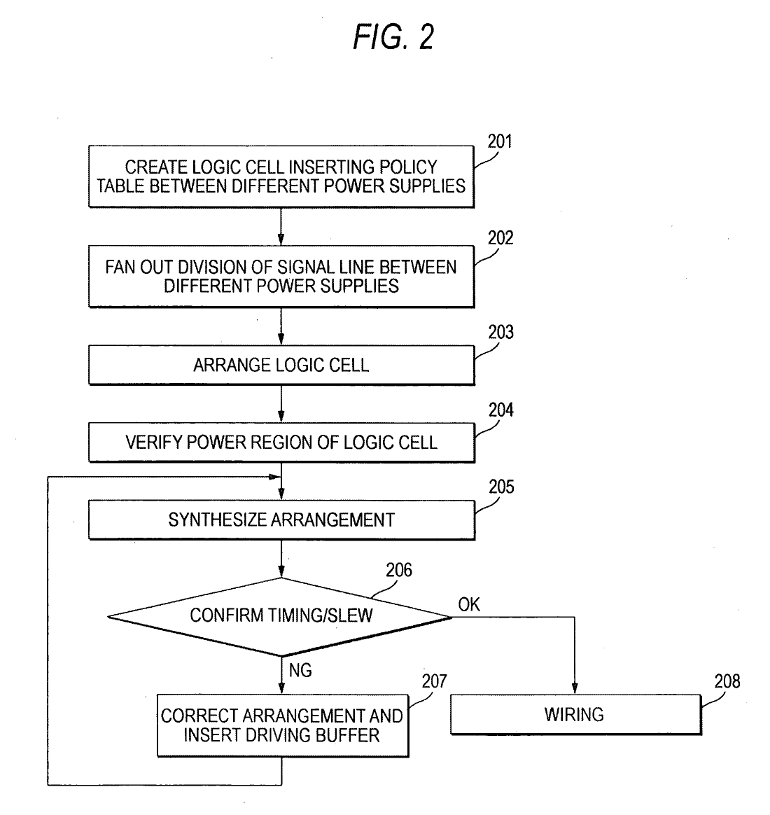

FIG. 2 is a flowchart showing a method of designing a layout of a multipower integrated circuit according to an embodiment of the invention. In FIG. 2, at a step 201, a logic cell inserting policy table between different power supplies is created.

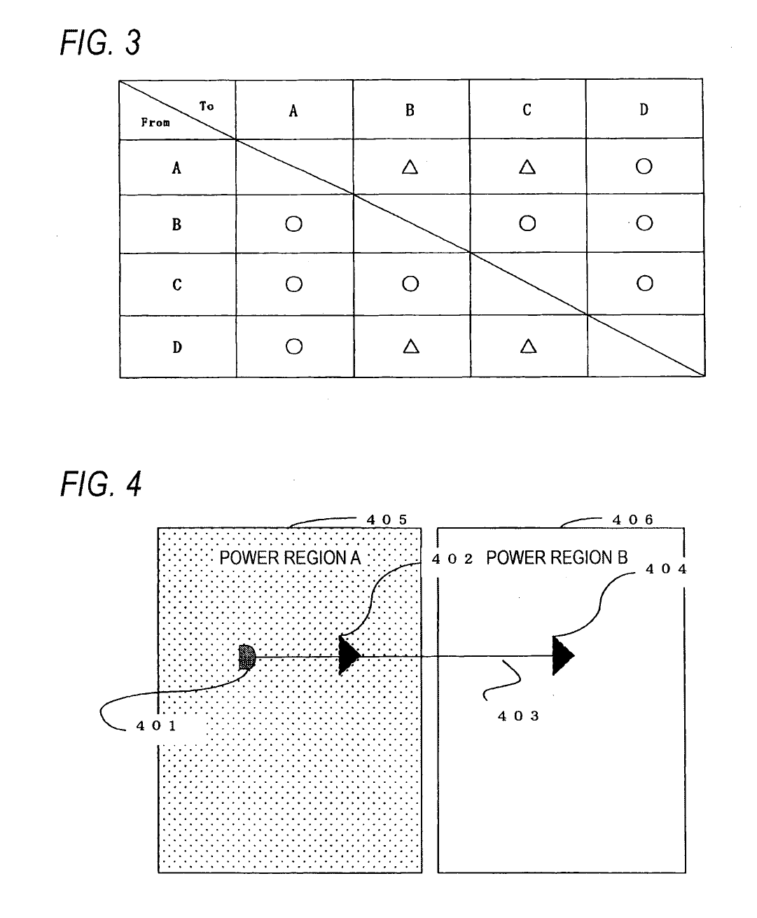

A table in FIG. 3 indicates an example. It is indicated that a signal is transmitted/received across the different power regions by any of a level fixing device, a driving buffer and other gates. In the table, an axis of ordinates represents a power region on an output side of a signal and an axis of abscissas represents a power region on a receiving side of the signal.

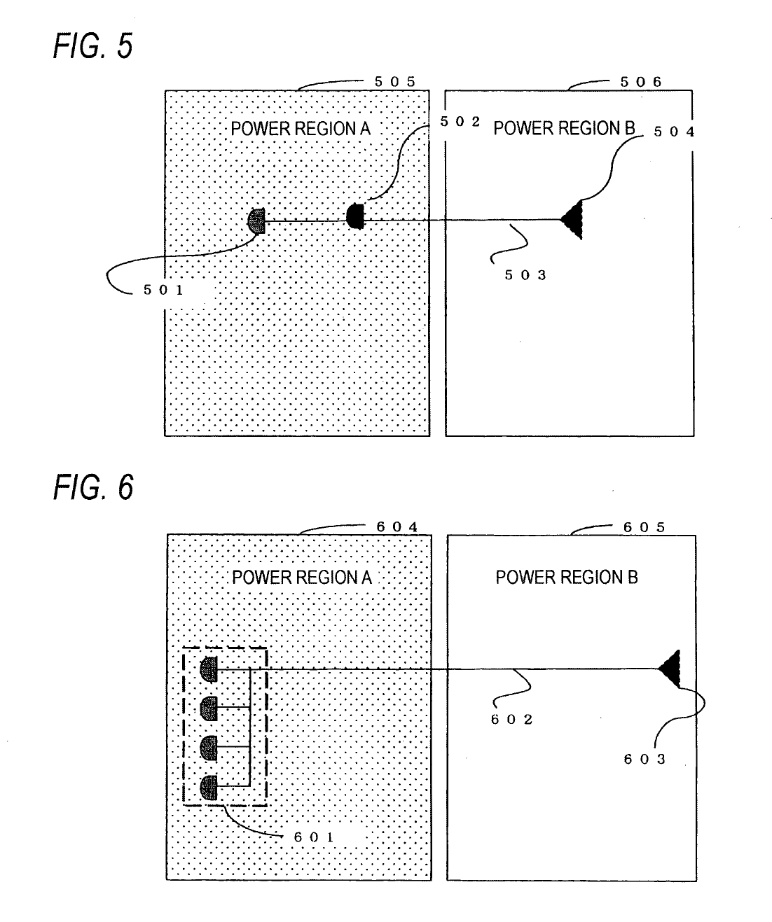

Circular and angular marks in the table indicate a relationship between the level fixing device and the driving buffer on the output and input sides. The circular mark represents a case shown in FIG. 5 in which a signal is output from the driving buffer or a normal gate and is received by the level fixing device. The triangular mark represents a case shown in FIG. 4 in which a signal is output from the level fixing device and is received by the buffer or the normal gate.

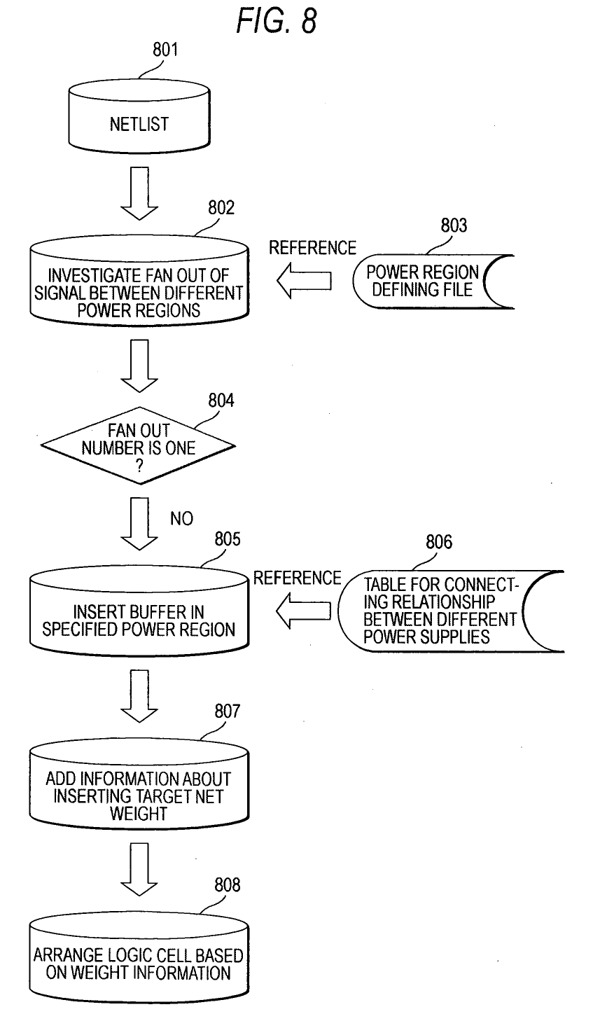

At a step 202, coordinates of a logic cell on each of the output and input sides are extracted for the signal to be transmitted across the different power supplies. In the case in which the signal to be transmitted across the different power supplies is subjected to multibranching as shown in FIG. 6, a fan out division of an interface signal between the different power supplies is carried out in accordance with a flowchart of FIG. 8 in order to implement the best interface structure in consideration of the arrangement of the logic cell.

In FIG. 8, an investigation 802 of a multi-fan out of the signal to be transmitted across the different power supplies is executed by a net list 801 and a power region recognizing file 803. For a fan out which is not one, the driving buffer is inserted in the power regions on both sides through a specified power region buffer insertion 805. By the insertion of the driving buffer, it is possible to implement a one-to-one circuit structure in a connecting relationship between the different power supplies. Thus, it is possible to improve a slew between the different power supplies.

Referring to a net between the different power supplies in which the buffer is inserted, moreover, an arrangement weight is given to the net through an inserting target net weight information addition 807. Logic cells connected to the target net are arranged close to each other by a logic cell arrangement 808 based on weight information.

At a subsequent arrangement synthesizing step 204, a signal between the different power supplies is excluded from an optimizing target. However, the signals excluded by the processing are one-to-one connected and the cells themselves are arranged close to each other. Therefore, there are few possibilities that a timing violation might be generated by a slew. Consequently, it is possible to automatically execute a timing optimization processing of one whole chip including a portion between the different power supplies.

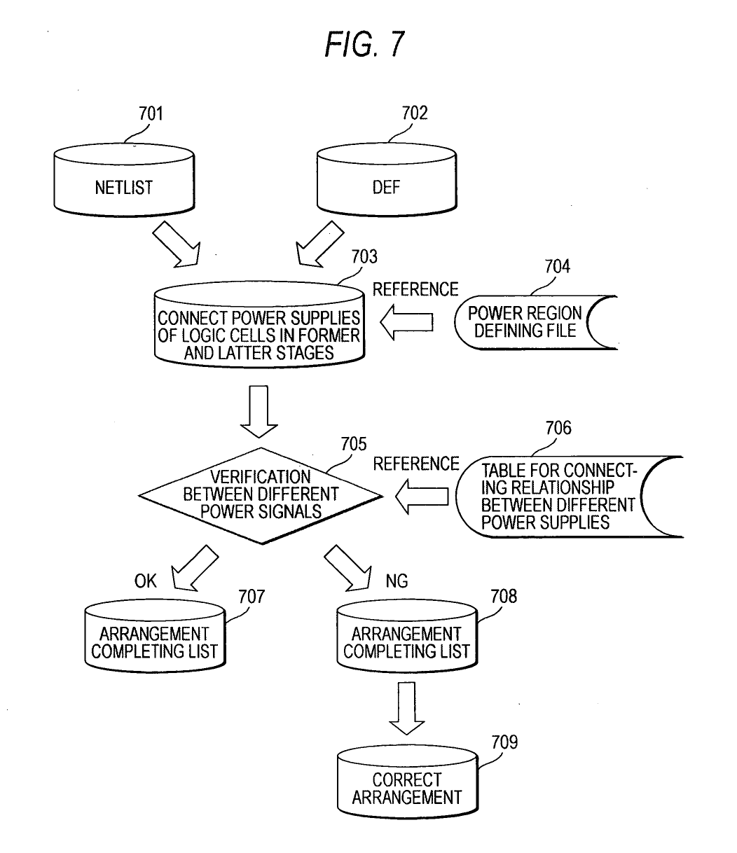

After a logic cell arrangement of a step 203, it is decided whether a logic cell is arranged in a correct power region at the step 204 based on coordinates of the arrangement of the logic cell and a logic cell inserting policy table created at the step 201. FIG. 7 is a flowchart showing a verifying method.

In FIG. 7, information about a connection of the power supply is extracted at a step 703 based on a net list 701 having information about a cell structure, a DEF 702 having information about an arrangement and a power region recognizing file 704, and a decision is carried out in a verification 705 between different power signals through a table 706 for a connecting relationship between different power supplies.

As a result of the decision, in the case in which the arrangement is not carried out in a supposed region, an arrangement correcting list 708 is automatically created and an arrangement correction 709 is executed so as to have the arrangement in correct power region coordinates. When the logic cell is arranged in the correct power region for all of the cells, an arrangement completing list 707 is output. Then, a general layout designing process is carried out after a step 205.

In the method of designing a layout of a multipower integrated circuit according to the invention, an optimum logic cell structure and arrangement for a signal to be transmitted across different power supplies is implemented. Consequently, it is possible to suppress the generation of slew and timing errors at subsequent steps and to shorten a layout design period, and to enhance a reliability. Consequently, the method is useful for a semiconductor layout designing technique.

What is claimed is:

1. A method of designing a layout of a multipower integrated circuit, comprising:
a step of defining a permitted connecting relationship of an interface signal between different power supplies;
a step of extracting the interface signal between the different power supplies based on information about each power region and information about a cell connection;
a step of optimizing a circuit for the interface signal between the different power supplies;
a logic cell arranging step;
a step of verifying a logic cell arrangement of the interface signal between the different power supplies;
an arrangement synthesizing step;
a step of confirming a timing and a slew before wiring; and
a wiring step.

2. The layout designing method according to claim 1, wherein at the circuit optimizing step, a fan out division of the interface signal between the different power supplies is carried out, and a buffer is inserted in such a manner that a transmitting/receiving relationship of the interface signal thus divided is set to be one to one.

3. The layout designing method according to claim 2, wherein at the logic cell arranging step, an arrangement restriction is given in such a manner that logic cells related to a transmission/receipt of the interface signal between the different power supplies are arranged close to each other based on net information processed at the step of optimizing a circuit for the interface signal between the different power supplies, thereby carrying out the arrangement of the logic cells.

4. The layout designing method according to claim 3, wherein at the step of verifying a logic cell arrangement, whether the logic cell related to the transmission/receipt of the interface signal between the different power supplies is arranged in a correct power region in the logic cell arrangement processed at the logic cell arranging step is verified by using net information, power region defining information and cell arrangement coordinate information.

5. The layout designing method according to claim 4, wherein in the case in which the logic cell related to the transmission/receipt of the interface signal between the different power supplies is not arranged in the correct power region, a correction for arranging the logic cell in a correct power region is carried out by using the net information, the power region defining information and the cell arrangement coordinate information.

6. The layout designing method according to claim 1, wherein a definition of the permitted connecting relationship of the interface signal between the different power supplies is represented in a two-dimensional table in which all power systems are provided on output and input sides, respectively.

7. The layout designing method according to claim 1, wherein the different power regions include a power cutoff region and a non-power cutoff region.
